(19) United States
(12) Patent Application Publication
(10) Pub. No.: US 2026/0197640 A1
(43) Pub. Date: Jul. 9, 2026

(54) METHOD FOR DUAL-SIM COMMUNICATION, ELECTRONIC DEVICE, AND MACHINE-READABLE STORAGE MEDIUM

(71) Applicant: Hefei TUGE Technologies Co., Ltd., Hefei (CN)

(72) Inventors: Tianming LV, Shanghai (CN); Hao ZHOU, Shanghai (CN); Kaihang WANG, Shanghai (CN)

(73) Assignee: Hefei TUGE Technologies Co., Ltd., Hefei (CN)

(21) Appl. No.: 19/130,556

(22) PCT Filed: May 17, 2023
(86) PCT No.: PCT/CN2023/094807

§ 371 Date: May 16, 2025

(30) Foreign Application Priority Data
Nov. 17, 2022 (CN) 202211440035.8

(51) Int. Cl. H04W 12/06; H04W 8/20; H04W 48/18; H04W 88/06

(52) U.S. Cl. CPC H04W 12/06; H04W 8/20; H04W 48/18; H04W 88/06

(57) ABSTRACT

A method for dual-SIM communication is applicable to an electronic device equipped with a physical SIM card. The method includes: activating the physical SIM card and successfully registering the physical SIM card with a network, and establishing a data channel for the physical SIM card; based on the data channel, acquiring a cloud SIM card assigned by a cloud SIM card server, and acquiring authentication response data acquired by initiating a registration authentication request by the cloud SIM card to a SIM card pool; and performing dual-SIM communication based on the physical SIM card and the cloud SIM card. According to the method, dual-SIM communication is implemented based on a primary-backup configuration of a physical SIM card and the cloud SIM card employed in the electronic device. The physical SIM card serves as both a data card and an authentication card for the cloud SIM card.

### CROSS REFERENCE TO THE RELATED APPLICATIONS

This application is the national phase entry of International Application No. PCT/CN2023/094807, filed on May 17, 2023, which is based upon and claims priority to Chinese Patent Application No. 202211440035.8, filed on Nov. 17, 2022, the entire contents of which are incorporated herein by reference.

### TECHNICAL FIELD

Embodiments of the present disclosure relate to the technical field of information communications, and in particular, relate to a method for dual-SIM communication, an electronic device, and a machine-readable storage medium.

### BACKGROUND

Currently, a dual-SIM dual-standby electronic device supports subscriber identification module (SIM) cards from different network operators to access different network services. Typically, one SIM card is used as a primary card which is from a first operator for providing data and voice services, and the other SIM card is registered with a 2G, 3G, 4G, or 5G network. One of these networks may be manually selected by a user or automatically selected by a terminal to provide data or voice services.

The electronic device is equipped with a primary SIM card switching threshold. In a case where the communication indicators of the first network from the first operator in the current area fall below the threshold, the data channel is switched to the other SIM card, enabling network switching between the two SIM cards in the electronic device. However, this method relies on the network environment of the physical SIM card and fails to combine the local network conditions for optimized network configuration.

### SUMMARY

Embodiments of the present disclosure provide a method for dual-SIM communication, an electronic device, and a machine-readable storage medium. By a primary-backup configuration of a physical SIM card and a cloud SIM card in the electronic device, dual-path protection is provided for users.

In one aspect, some embodiments of the present disclosure provide a method for dual-SIM communication, applicable to an electronic device, wherein the electronic device is equipped with a physical SIM card. The method includes:
activating the physical SIM card and successfully registering the physical SIM card with a network, and establishing a data channel for the physical SIM card;
based on the data channel, acquiring a cloud SIM card assigned by a cloud SIM card server, and acquiring authentication response data acquired by initiating a registration authentication request by the cloud SIM card to a SIM card pool; and
performing dual-SIM communication based on the physical SIM card and the cloud SIM card.

In some embodiments, one or a plurality of cloud SIM cards assigned by the cloud SIM card server are acquired;
wherein in a case where a plurality of cloud SIM cards are acquired, a plurality of pieces of authentication response data are acquired in response to the plurality of cloud SIM cards initiating a registration authentication request to the SIM card pool; and
correspondingly, performing dual-SIM communication based on the physical SIM card and the cloud SIM card comprises: performing dual-SIM communication based on the physical SIM card and a cloud SIM card with a best network quality.

In some embodiments, performing dual-SIM communication based on the physical SIM card and the cloud SIM card includes:
monitoring first communication quality data of the physical SIM card and second communication quality data of the cloud SIM card; and
in a case where the first communication quality data is greater than the second communication quality data, selecting a network of the physical SIM card as a primary network for data communication and using a network of the cloud SIM card as a backup network; or in a case where the first communication quality data is not greater than the second communication quality data, selecting a network of the cloud SIM card as a primary network for data communication and using a network of the physical SIM card as a backup network.

In some embodiments, the method further includes:
monitoring a data link of the primary network; and
in a case where the data link of the primary network is normal, continuing using the primary network for data communication, and continuously monitoring the data link of the primary network;
in a case where the data link of the primary network is abnormal, monitoring a data link of the backup network, and selecting the backup network as the primary network for data communication in a case where the data link of the backup network is normal;
in a case where data links of both the primary network and the backup network are abnormal, comparing a network quality of the primary network and a network quality of the backup network, and selecting one of the primary network and the backup network with a better quality as the primary network for data communication.

In some embodiments, in the case where the data links of both the primary network and the backup network are abnormal, the method further includes:
acquiring a backup cloud SIM card from the cloud SIM card server based on a data channel of the cloud SIM card, and initiating registration authentication for the backup cloud SIM card to the SIM card pool over the data channel of the physical SIM card; and
subsequent to successful authentication, performing network diagnostics for the backup cloud SIM card, and replacing the cloud SIM card with the backup cloud SIM card for data communication in response to a network of the backup cloud SIM card being normal; or
comparing network qualities of the network of the physical SIM card, the network of the cloud SIM card, and the network of the backup cloud SIM card, and selecting a network with an optimal network quality as the primary network for data communication.

In some embodiments, the physical SIM card and the cloud SIM card home to different network operators; and the primary network is the network of the physical SIM card and the backup network is the network of the cloud SIM card, or the primary network is the network of the cloud SIM card and the backup network is the network of the physical SIM card.

In some embodiments, the physical SIM card includes, but is not limited to, an eSIM card and a surface-mount SIM card.

In another aspect, some embodiments of the present disclosure provide an electronic device, equipped with a physical SIM card, the electronic device comprising an activation module, an acquisition module, and a communication module; wherein
the activation module is configured to activate the physical SIM card and successfully register the physical SIM card with a network, and establish a data channel for the physical SIM card;
the acquisition module is configured to, based on the data channel, acquire a cloud SIM card assigned by a cloud SIM card server, and acquire authentication response data acquired by initiating a registration authentication request by the cloud SIM card to a SIM card pool; and
the communication module is configured to perform dual-SIM communication based on the physical SIM card and the cloud SIM card.

In some embodiments, one or a plurality of cloud SIM cards assigned by the cloud SIM card server are acquired;
wherein in a case where a plurality of cloud SIM cards are acquired, the acquisition module is further configured to acquire a plurality of pieces of authentication response data in response to the plurality of cloud SIM cards initiating a registration authentication request to the SIM card pool; and
correspondingly, the communication module is further configured to perform dual-SIM communication based on the physical SIM card and a cloud SIM card with a best network quality.

In some embodiments, the communication module includes a communication quality monitoring unit and a communication selection unit; wherein
the communication quality monitoring unit is configured to monitor first communication quality data of the physical SIM card and second communication quality data of the cloud SIM card; and
the communication selection unit is configured to, in a case where the first communication quality data is greater than the second communication quality data, select a network of the physical SIM card as a primary network for data communication and select a network of the cloud SIM card as a backup network; or in a case where the first communication quality data is not greater than the second communication quality data, select a network of the cloud SIM card as a primary network for data communication and select a network of the physical SIM card as a backup network.

In some embodiments, the communication quality monitoring unit is further configured to monitor a data link of the primary network; and
correspondingly, the communication selection unit is further configured to, in a case where the data link of the primary network is normal, continue using the primary network for data communication, and continuously monitor the data link of the primary network;
in a case where the data link of the primary network is abnormal, monitor a data link of the backup network, and select the backup network as the primary network for data communication in a case where the data link of the backup network is normal;
in a case where data links of both the primary network and the backup network are abnormal, compare a network quality of the primary network and a network quality of the backup network, and select one of the primary network and the backup network with a better quality as the primary network for data communication.

In some embodiments, the physical SIM card and the cloud SIM card home to different network operators.

Some embodiments of the present disclosure further provide a device for dual-SIM communication. The device includes:
a processor, an encryptor, a memory, and one or more computer programs that are stored in the memory and runnable on the processor; wherein the one or more computer programs, when loaded and run by the processor, cause the processor to perform the method for dual-SIM communication as described above.

Some embodiments of the present disclosure provide a machine-readable storage medium storing one or more executable instructions, wherein the one or more executable instructions, when loaded and executed by a machine, cause the machine to perform the method for dual-cloud SIM card communication as described above.

It can be seen that the above technical solutions enable an electronic device to communicate by employing a physical SIM card in conjunction with a cloud SIM card. The physical SIM card serves both as a data card and as an authentication card for the cloud SIM card. In practice, the physical SIM card includes, but is not limited to, an eSIM card or a surface-mount SIM card. The coverage area of the physical SIM card affects the stability and usage range of the dual-SIM network. This solution dynamically assigns two different operator networks to the electronic device and continuously monitors both operator networks, such that the two optimal operator networks are always selected to serve as primary and backup for each other. In a case where the data connection is established based on either the physical SIM card or the cloud SIM card, the primary network is selected based on the network performance during different time periods. This allows for a timely switching to another operator for communication where the network quality of one operator degrades, such that optimal network quality and reliability are achieved.

The embodiments of the present disclosure ensure that at international roaming borders or in cases of continuously crossing multiple countries, the two optimal operator networks may always be selected to provide services. Furthermore, based on the physical SIM card, by reliably connecting to and activate a local cloud SIM card with lower tariffs, international roaming costs are saved, and network reliability and communication quality are enhanced.

### BRIEF DESCRIPTION OF THE DRAWINGS

For clearer descriptions of the technical solutions according to the specific embodiments of the present disclosure, hereinafter brief description is given with reference to the accompanying drawings for illustrating the embodiments and the related art. However, those skilled in the art should understand that the accompanying drawings are merely for describing some examples of the present disclosure, but are not intended to limit the scope of the present disclosure.

FIG. 1 is a schematic flowchart of a method for dual-SIM communication according to some embodiments of the present disclosure;

FIG. 2 is a schematic flowchart of monitoring and switching a method for cloud SIM card communication by a dual-SIM card network according to some embodiments of the present disclosure;

FIG. 3 is a schematic structural diagram of an electronic device according to some embodiments of the present disclosure;

FIG. 4 is a schematic structural diagram of an electronic device according to some embodiments of the present disclosure; and

FIG. 5 is a schematic structural diagram of a device for dual-SIM card communication according to some embodiments of the present disclosure.

### DETAILED DESCRIPTION OF THE EMBODIMENTS

The technical solutions according to embodiments of the present disclosure are clearly and thoroughly described hereinafter with reference to the accompanying drawings illustrating the embodiments of the present disclosure. Those skilled in the art should understand that the embodiments described herein are merely exemplary ones, but are not all the embodiments of the present disclosure. Based on the embodiments in the present disclosure, those skilled in the art may make any suitable modifications or variations to derive all other embodiments.

Currently, in a dual-SIM dual-standby electronic device, both SIM cards remain in a standby mode, and data or voice communication is carried out on one SIM card. In a case where the communication indicators of the first network from the first operator in the current area fall below the switching threshold of the primary SIM card, the data channel is switched to the other SIM card, which carries out data communication over the second network. This enables network switching between the two SIM cards in the electronic device. However, this method only relies on the network environment of only one SIM card, for example, the physical SIM card, and fails to combine the local network conditions for optimized network configuration.

In view of this, some embodiments of the present disclosure provide a dual-SIM communication solution. First, a physical SIM card is activated to register with a network. Connection with a cloud SIM card server is established based on the physical SIM card to acquire a cloud SIM card from an operator different from that of the physical SIM card. A data channel of the physical SIM card is used to complete the registration of the cloud SIM card, thereby enabling the terminal device to simultaneously possess capabilities of establishing data connection to two different operator networks. A primary data channel is then selected to provide services based on factors such as network quality and tariffs.

In the cloud SIM card registration process according to the embodiments of the present disclosure, the cloud SIM card with the optimal network quality at a given time is used to provide data services. This cloud SIM card with the optimal quality and the physical SIM card form 1+1 dual-channel network capabilities. The networks of the physical SIM card and the cloud SIM card, from dual operators, serve as backups for each other, such that the reliability and performance of data services are enhanced.

The above technical solutions are described in detail hereinafter with reference to specific embodiments.

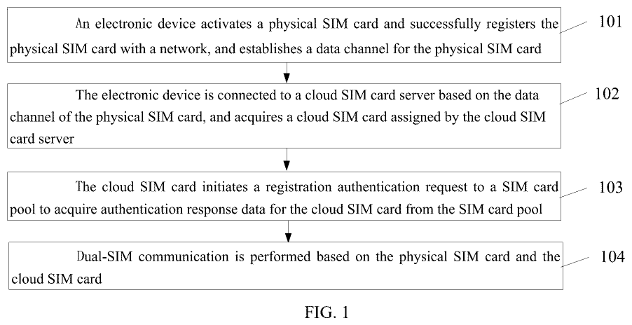

FIG. 1 is a schematic flowchart of a method for dual-SIM communication according to some embodiments of the present disclosure.

In step 101, an electronic device activates a physical SIM card and successfully registers the physical SIM card with a network, and establishes a data channel for the physical SIM card.

In an electronic device according to the embodiments of the present disclosure, a physical SIM card is provided. The physical SIM card needs to register with a network before communication. The physical SIM card includes, but is not limited to, an embedded-SIM (eSIM) card or a surface-mount SIM card. As for the eSIM card, a traditional SIM card is directly embedded onto a chip of the electronic device, rather than being added to the electronic device as an independent and removable component. A surface-mount SIM card may be pre-installed in an electronic device, which may be an Internet of things (IoT) device. The surface-mount SIM card is a non-removable physical SIM card capable of independently completing authentication to achieve Internet communication, and a data channel of the surface-mount SIM card is configured to assist the cloud SIM card in completing the authentication of the cloud SIM card.

In step 102, the electronic device is connected to a cloud SIM card server based on the data channel of the physical SIM card, and acquires a cloud SIM card assigned by the cloud SIM card server.

Specifically, a SIM card pool is configured in the cloud SIM card server, and the SIM card pool contains card information for a plurality of cloud SIM cards homing to different network operators. In the embodiments of the present disclosure, the electronic device acquires one cloud SIM card from the cloud SIM card server based on the data channel of the physical SIM card. In some embodiments, the cloud SIM card and the physical SIM card home to different network operators.

In the embodiments of the present disclosure, the electronic device may determine the operator. In a case where a plurality of cloud SIM cards from different network operators are configured in the cloud SIM card server, the electronic device, based on the data channel established for the physical SIM card, acquires a cloud SIM card from the cloud SIM card server, and determines whether the operator of the cloud SIM card is the same as the operator of the physical SIM card. In a case where the operators are different, the operation for acquiring the cloud SIM card is concluded. In a case where the operators are the same, the electronic device continues to acquire a cloud SIM card from the cloud SIM card server based on the data channel established for the physical SIM card, until the acquired cloud SIM card and the physical SIM card operator home to different network operators.

Preferably, in this step, the electronic device may acquire a plurality of cloud SIM cards assigned by the cloud SIM card server, and each cloud SIM card and the physical SIM card home to different network operators.

In step 103, the cloud SIM card initiates a registration authentication request to a SIM card pool to acquire authentication response data for the cloud SIM card from the SIM card pool.

In practical application, the cloud SIM card, over the data channel of the physical SIM card, transmits a registration authentication request to the SIM card pool, and acquires authentication response data returned by the SIM card pool to complete the registration. The data channel of the cloud SIM card may be configured to acquire a backup cloud SIM card from the cloud SIM card server. With the backup cloud SIM card, registration authentication fails to be completed. The registration authentication needs to be completed based on the data channel of the physical SIM card.

In some embodiments, in a case where a plurality of cloud SIM cards are acquired in step 102, and each cloud SIM card homes to a different operator than the physical SIM card, each of the plurality of cloud SIM cards is registered and authenticated separately, and the cloud SIM card with an optimal communication quality is acquired.

In step 104, dual-SIM communication is performed based on the physical SIM card and the cloud SIM card.

In this step, first communication quality data of the physical cloud SIM card and second communication quality data of the cloud SIM card are monitored, and data communication is performed based on the physical SIM card in a case where the first communication quality data is superior over the second communication quality data (or data reflecting a better communication quality of the physical SIM card is more than data reflecting a better communication quality of the cloud SIM card), or data communication is performed based on the cloud SIM card in a case where the first communication quality data is not superior over the second communication quality data.

According to the embodiments of the present disclosure, an electronic device is enabled to communicate by employing a physical SIM card in conjunction with a cloud SIM card. The physical SIM card serves both as a data card and as an authentication card for the cloud SIM card. The physical SIM card includes, but is not limited to, an eSIM card or a surface-mount SIM card. The coverage area of the physical SIM card affects the stability and usage range of the dual-SIM network, and this solution dynamically assigns two different operator networks to the electronic device.

By performing network quality assessment for the physical SIM card and the cloud SIM card, the two optimal operator networks are always selected to serve as primary and backup for each other. In a case where the data connection is established based on either the physical SIM card or the cloud SIM card, the primary network is selected based on the network performance during different time periods. This allows for a timely switching to another operator for communication where the network quality of one operator degrades, such that optimal network quality and reliability are achieved.

The embodiments of the present disclosure ensure that at international roaming borders or in cases of continuously crossing multiple countries, the two optimal operator networks may always be selected to provide services. Furthermore, based on the physical SIM card, by reliably connecting to and activate a local cloud SIM card with lower tariffs, international roaming costs are saved, and network reliability and communication quality are enhanced.

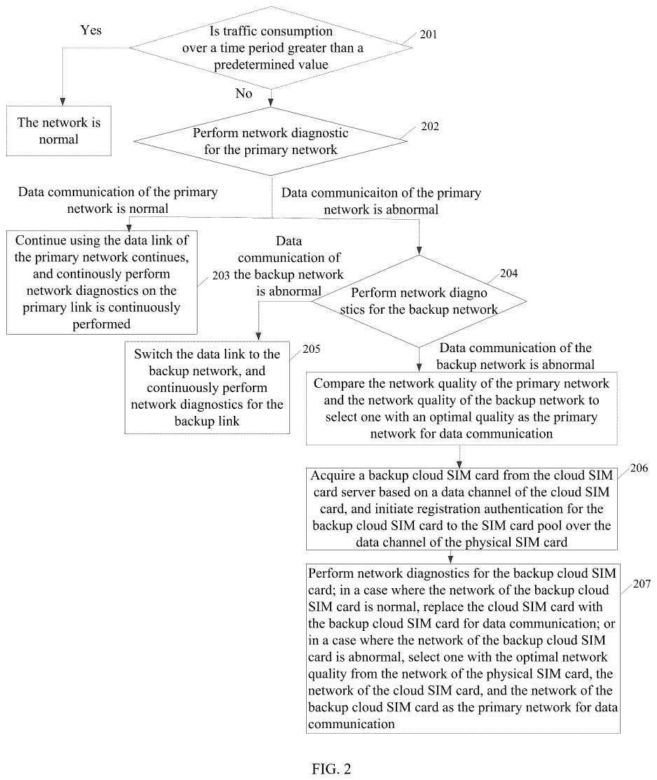

Hereinafter referring to FIG. 2, a process for dual-SIM network monitoring and network switching for communication according to some embodiments of the present disclosure is described in detail hereinafter.

In step 201, traffic consumption over a time period is monitored. In a case where the traffic consumption is greater than a predetermined threshold, the network is normal; and otherwise, the network is abnormal and step 202 is performed.

In practical applications, the traffic consumption within a time period T1 is monitored to determine whether the traffic consumption is greater than a predetermined threshold F. The parameter T1 may be configured (60 seconds by default, which is adjustable), and the traffic threshold F (100 Kbit by default, which is adjustable). In a case where the traffic exceeds 100 Kbit within 60 seconds, the network is considered normal; and otherwise, the network is flagged for further detection.

In step 202, network diagnostics is performed for the primary cloud SIM card. In a case where data communication of the primary cloud SIM card is normal, step 203 is performed. In a case where data communication of the primary cloud SIM card is abnormal, the operator of the cloud SIM card is switched and step 204 is performed.

In this step, ping tests and network speed tests are performed on the primary network. Parameters such as packet loss and latency of pings to a universal address are observed, and network upload and download capabilities are assessed to determine where the network is normal.

In a case where the latency of N consecutive pings on the primary network is less than a predetermined value, the primary network is considered normal, and communication is maintained using the primary network, with continuous data monitoring performed on the data link of the primary network.

In step 203, the data link of the primary network continues to be used, and network diagnostics on the primary link is continuously performed.

In practical application, the primary network may be either provided by the physical SIM card or by the cloud SIM card, that is, either a network of the physical SIM card, or a network of the cloud SIM card. In a case where the primary network is the physical SIM card (the physical SIM card including, but not limited to, an eSIM card or a surface-mount SIM card) and the backup network is the cloud SIM card, and the data link of the physical SIM card is normal, communication is maintained using the network of the physical SIM card, and the data link of the network of the physical SIM card is continuously monitored.

In a case where the primary network is the network of the cloud SIM card and the backup network, and the data link of the physical SIM card is normal, data communication is maintained using the network of the cloud SIM card, and the data link of the network of the cloud SIM card is continuously monitored.

In step 204, network diagnostics is performed for the backup network. In a case where the backup network is normal, step 205 is performed. In a case where the backup network is abnormal, the network quality of the primary network and the network quality of the backup network are compared to select one with an optimal quality as the primary network for data communication, and step 206 is performed.

In a case where the ping latency measured on the primary network is greater than or equal to a predetermined value, the primary network is considered abnormal. A ping test is then performed on the backup network. In a case where the latency of N consecutive pings on the backup network is less than the predetermined value, the backup network is considered normal, and the data link is switched to the backup network.

In a case where the ping latency measured on the backup network is greater than or equal to the predetermined value, the backup network is considered abnormal.

In step 205, the data link is switched to the backup network, and network diagnostics is continuously performed for the backup link.

In practical application, in a case where the primary network is the network of the physical SIM card and the backup network is the network of the cloud SIM card, and the data link of the primary network is abnormal, the data link of the network of the cloud SIM card is monitored. In a case where the data link of the network of the cloud SIM card is normal, the primary network is switched to the network of the cloud SIM card for data communication, that is, the network of the cloud SIM card serves as the primary network.

In practical application, in a case where the primary network is the network of the cloud SIM card and the backup network is the network of the physical SIM card, and the data link of the primary network is abnormal, the data link of the network of the physical SIM card is monitored. In a case where the data link of the network of the physical SIM card is normal, the primary network is switched to the network of the physical SIM card for data communication, that is, the network of the physical SIM card serves as the primary network.

In the embodiments of the present disclosure, upon completion of the authentication of the cloud SIM card and establishment of the data link, network quality information is acquired by performing upload, download, and ping tests on a speed testing platform using the network of the cloud SIM card. For a plurality of cloud SIM cards, upon completion of authentication of each cloud SIM card, speed testing is performed to determine the network quality of the cloud SIM cards.

In step 206, a backup cloud SIM card is acquired from the cloud SIM card server based on a data channel of the cloud SIM card, and registration authentication for the backup cloud SIM card is initiated to the SIM card pool over the data channel of the physical SIM card. Where the authentication is successful, step 207 is performed.

In practical application, in a case where the primary network is the network of the physical SIM card and the backup network is the network of the cloud SIM card, and the data links of both the network of the physical SIM card and the network of the cloud SIM card are abnormal, network diagnostics is performed for the acquired backup cloud SIM card. In a case where the network of the backup cloud SIM card is normal, the cloud SIM card is replaced with the backup cloud SIM card such that the network of the backup cloud SIM card serves as the primary network for data communication. In a case where the network of the backup cloud SIM card is abnormal, the network qualities of the network of the physical SIM card, the network of the cloud SIM card, and the network of the backup cloud SIM card are compared to select one with the optimal network quality is selected as the primary network for data communication.

In practical application, in a case where the primary network is the network of the cloud SIM card and the backup network is the network of the physical SIM card, and the data links of both the network of the cloud SIM card and the network of the physical SIM card are abnormal, network diagnostics is performed for the acquired backup cloud SIM card. In a case where the network of the backup cloud SIM card is normal, the cloud SIM card is replaced with the backup cloud SIM card such that the network of the backup cloud SIM card serves as the primary network for data communication. In a case where the network of the backup cloud SIM card is abnormal, the network qualities of the network of the physical SIM card, the network of the cloud SIM card, and the network of the backup cloud SIM card are compared to select one with the optimal network quality is selected as the primary network for data communication.

In step 207, network diagnostics is performed for the backup cloud SIM card. In a case where the network of the backup cloud SIM card is normal, the cloud SIM card is replaced with the backup cloud SIM card for data communication. In a case where the network of the backup cloud SIM card is abnormal, one with the optimal network quality is selected from the network of the physical SIM card, the network of the cloud SIM card, and the network of the backup cloud SIM card as the primary network for data communication.

In the embodiments of the present disclosure, dual-SIM communication is performed based on the physical SIM card and the cloud SIM card. In a case where the primary network is abnormal, the primary network is switched to the backup network for data communication. The primary network may be either the physical SIM card or the cloud SIM card, wherein the physical SIM card includes, but is not limited to, an eSIM card and a surface-mount SIM card. In a case where both the physical SIM card and the cloud SIM card are abnormal, a backup cloud SIM card is employed. In a case where the network of the backup cloud SIM card is normal, the cloud SIM card is replaced with the backup cloud SIM card for data communication, i.e., communication is performed based on the network of the backup cloud SIM card. In a case where the network of the backup cloud SIM card is abnormal, one with the optimal network quality is selected from the network of the physical SIM card, the network of the cloud SIM card, and the network of the backup cloud SIM card as the primary network for data communication.

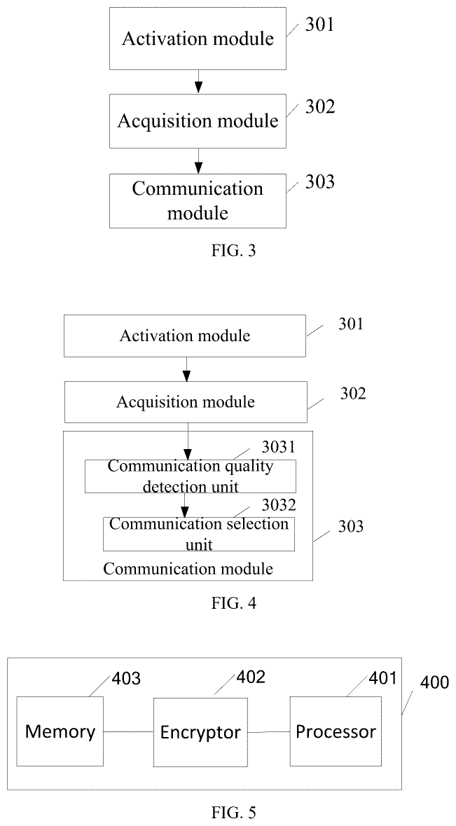

FIG. 3 is a schematic structural diagram of an electronic device according to some embodiments of the present disclosure. The electronic device is equipped with a physical SIM card. The electronic device includes an activation module 301, an acquisition module 302, and a communication module 303.

The activation module 301 is configured to activate the physical SIM card and successfully register the physical SIM card with a network, and establish a data channel for the physical SIM card.

The acquisition module 302 is configured to, based on the data channel, acquire a cloud SIM card assigned by a cloud SIM card server, and acquire authentication response data acquired by initiating a registration authentication request by the cloud SIM card to a SIM card pool.

The communication module 303 is configured to perform dual-SIM communication based on the physical SIM card and the cloud SIM card.

In some embodiments, the physical SIM card in the electronic device includes, but is not limited to, an eSIM card and a surface-mount SIM card.

In some embodiments, one or a plurality of cloud SIM cards assigned by the cloud SIM card server are acquired.

In a case where a plurality of cloud SIM cards are acquired, the acquisition module 302 is further configured to acquire a plurality of pieces of authentication response data in response to the plurality of cloud SIM cards initiating a registration authentication request to the SIM card pool. The data channel of the cloud SIM card may be used to acquire a backup cloud SIM card from the cloud SIM card server. With the backup cloud SIM card, registration authentication fails to be completed. The registration authentication needs to be completed based on the data channel of the physical SIM card.

Correspondingly, the communication module 303 is further configured to perform dual-SIM communication based on the physical SIM card and a cloud SIM card with a best network quality.

In some embodiments, the communication module 303 includes a communication quality monitoring unit 3031 and a communication selection unit 3032.

The communication quality monitoring unit 3031 is configured to monitor first communication quality data of the physical SIM card and second communication quality data of the cloud SIM card.

The communication selection unit 3032 is configured to, in a case where the first communication quality data is greater than the second communication quality data, select a network of the physical SIM card as a primary network for data communication and select a network of the cloud SIM card as a backup network; or in a case where the first communication quality data is not greater than the second communication quality data, select a network of the cloud SIM card as a primary network for data communication and select a network of the physical SIM card as a backup network.

In some embodiments, the communication quality monitoring unit 3031 is further configured to monitor a data link of the primary network; and

correspondingly, the communication selection unit 3032 is further configured to: in a case where the data link of the primary network is normal, continue selecting the primary network for data communication, and continuously monitor the data link of the primary network;

in a case where the data link of the primary network is abnormal, monitor a data link of the backup network, and select the backup network as the primary network for data communication in a case where the data link of the backup network is normal; and

in a case where data links of both the primary network and the backup network are abnormal, compare a network quality of the primary network and a network quality of the backup network, and select one of the primary network and the backup network with a better quality as the primary network for data communication.

In the embodiments of the present disclosure, the physical SIM card and the cloud SIM card home to different network operators.

In the embodiments of the present disclosure, by activating the data channel of the physical SIM card, a cloud SIM card assigned by the cloud SIM card server is acquired, such that dual-SIM mutually backup communication is achieved between the physical SIM card and the cloud SIM card. In a case where the data connection is established based on either the physical SIM card or the cloud SIM card, the primary network is selected based on the network performance during different time periods. This allows for a timely switching to another operator for communication where the network quality of one operator degrades, such that optimal network quality and reliability are achieved. The embodiments of the present disclosure ensure that at international roaming borders or in cases of continuously crossing multiple countries, the two optimal operator networks may always be selected to provide services. Furthermore, based on the physical SIM card, by reliably connecting to and activate a local cloud SIM card with lower tariffs, international roaming costs are saved, and network reliability and communication quality are enhanced.

FIG. 5 is a schematic structural diagram of a device for dual-SIM communication according to some embodiments of the present disclosure.

The device 400 for dual-SIM communication includes a processor 401, an encryptor 402, a memory 403, and one or more computer programs that are stored in the memory and runnable on the processor, wherein the processor 401 is configured to load and run the one or more computer programs to cause the device 400 to perform the method for dual-SIM communication as described in the above embodiments.

For example, the processor 401 is a central processing unit (CPU) or the like. The memory 403 may include a random access memory, a flash memory, read-only memory, a programmable read-only memory, a non-volatile memory, a register, and the like. An encryption token is embedded in the encryptor 402. The memory 403 may store one or more executable instructions. The processor 401 may execute the one or more executable instructions stored in the memory 403 to perform the processes described herein.

Additionally, some embodiments of the present disclosure further provide a machine-readable storage medium. The machine-readable storage medium may store one or more executable instructions, which, when loaded and executed by a machine, cause the machine to perform the specific processes described above with reference to the method embodiments.

For example, the machine-readable storage medium may include, but is not limited to, a random access memory (RAM), a read-only memory (ROM), an electrically-erasable programmable read-only memory (EEPROM), a static random access memory (SRAM), a hard disk, a flash memory, and the like.

Those skilled in the art may envisage that various exemplary units and algorithm steps described with reference to the embodiments of the present disclosure given herein may be practiced in the form of electronic hardware or a combination of software and electronic hardware. Whether such functions are implemented in the form of software or hardware depends on the specific application of the technical solutions and the design restrictions. Those skilled in the art may implement the described functions by using different methods for each specific application. However, such implementation shall not be deemed as going beyond the scope of the present disclosure.

In several embodiments of the present disclosure, it should be understood that the disclosed system, apparatus, and method may be implemented in other manners. For example, categorization of the functional units in the present disclosure is merely made in terms of logical functionality. In practice, the categorization of the apparatus may also be achieved in any other form. For example, a plurality of units or components may be combined or integrated into another system. Additionally, the coupling between the various units may be either direct coupling or indirect coupling. In addition, functional units in the embodiments of the present disclosure may be integrated into one processing unit, or may be separate physical units.

In a case where the functions are implemented in a form of a software functional unit and sold or used as an independent product, the units may be stored in a machine-readable storage medium. Therefore, the technical solutions of the present disclosure may be embodied in the form of a software product. This software product may be stored in a machine-readable storage medium and may include several instructions to cause an electronic device to perform all or part of the processes described in the embodiments of the present disclosure. The storage medium includes a ROM, a RAM, a magnetic disk, a compact disc read-only memory (CD-ROM), or the like medium which is capable of storing program code.

Described above are merely specific embodiments of the present disclosure, and the scope of protection of the present disclosure are not limited thereto. Variations or substitutions that may be made by those skilled in the art within the technical scope disclosed in the present disclosure shall also fall within the scope of protection of the present disclosure.

What is claimed is:

1. A method for dual subscriber identification module (SIM) communication, applicable to an electronic device, the electronic device being equipped with a physical SIM card, the method comprising:
activating the physical SIM card and successfully registering the physical SIM card with a network, and establishing a data channel for the physical SIM card;
based on the data channel, acquiring a cloud SIM card assigned by a cloud SIM card server, and acquiring authentication response data acquired by initiating a registration authentication request by the cloud SIM card to a SIM card pool; and
performing dual-SIM communication based on the physical SIM card and the cloud SIM card.

2. The method according to claim 1, wherein one or a plurality of cloud SIM cards assigned by the cloud SIM card server are acquired;
wherein in a case where the plurality of cloud SIM cards are acquired, a plurality of pieces of authentication response data are acquired in response to the plurality of cloud SIM cards initiating the registration authentication request to the SIM card pool; and
correspondingly, performing dual-SIM communication based on the physical SIM card and the cloud SIM card comprises: performing dual-SIM communication based on the physical SIM card and a cloud SIM card with an optimal network quality.

3. The method according to claim 2, wherein performing dual-SIM communication based on the physical SIM card and the cloud SIM card comprises:
monitoring first communication quality data of the physical SIM card and second communication quality data of the cloud SIM card; and
in a case where the first communication quality data is greater than the second communication quality data, selecting a network of the physical SIM card as a primary network for data communication and selecting a network of the cloud SIM card as a backup network; or in a case where the first communication quality data is less than or equal to the second communication quality data, selecting a network of the cloud SIM card as a primary network for data communication and selecting a network of the physical SIM card as a backup network.

4. The method according to claim 3, further comprising:
monitoring a data link of the primary network; and
in a case where the data link of the primary network is normal, continuing using the primary network for data communication, and continuously monitor the data link of the primary network;
in a case where the data link of the primary network is abnormal, monitoring a data link of the backup network, and selecting the backup network as the primary network for data communication in a case where the data link of the backup network is normal; or
in a case where data links of both the primary network and the backup network are abnormal, comparing a network quality of the primary network and a network quality of the backup network, and selecting one of the primary network and the backup network with a better quality as the primary network for data communication.

5. The method according to claim 4, wherein in the case where the data links of both the primary network and the backup network are abnormal, the method further comprises:
acquiring a backup cloud SIM card from the cloud SIM card server based on a data channel of the cloud SIM card, and initiating registration authentication for the backup cloud SIM card to the SIM card pool over the data channel of the physical SIM card; and
subsequent to successful authentication, performing network diagnostics for the backup cloud SIM card, and replacing the cloud SIM card with the backup cloud SIM card for data communication in response to a network of the backup cloud SIM card being normal; or
comparing network qualities of the network of the physical SIM card, the network of the cloud SIM card, and the network of the backup cloud SIM card, and selecting a network with an optimal network quality as the primary network for data communication.

6. The electronic device according to claim 5, wherein the physical SIM card and the cloud SIM card home to different network operators; and the primary network is the network of the physical SIM card and the backup network is the network of the cloud SIM card, or the primary network is the network of the cloud SIM card and the backup network is the network of the physical SIM card.

7. The method according to claim 1, wherein the physical SIM card comprises an eSIM card and a surface-mount SIM card.

8. An electronic device, equipped with a physical SIM card, the electronic device comprising an activation module, an acquisition module, and a communication module; wherein
the activation module is configured to activate the physical SIM card and successfully register the physical SIM card with a network, and establish a data channel for the physical SIM card;
the acquisition module is configured to, based on the data channel, acquire a cloud SIM card assigned by a cloud SIM card server, and acquire authentication response data acquired by initiating a registration authentication request by the cloud SIM card to a SIM card pool; and
the communication module is configured to perform dual-SIM communication based on the physical SIM card and the cloud SIM card.

9. The electronic device according to claim 8, wherein one or a plurality of cloud SIM cards assigned by the cloud SIM card server are acquired;
wherein in a case where the plurality of cloud SIM cards are acquired, the acquisition module is further configured to acquire a plurality of pieces of authentication response data in response to the plurality of cloud SIM cards initiating the registration authentication request to the SIM card pool; and
correspondingly, the communication module is further configured to perform dual-SIM communication based on the physical SIM card and a cloud SIM card with a best network quality.

10. The electronic device according to claim 9, wherein the communication module comprises a communication quality monitoring unit and a communication selection unit; wherein
the communication quality monitoring unit is configured to monitor first communication quality data of the physical SIM card and second communication quality data of the cloud SIM card; and
the communication selection unit is configured to, in a case where the first communication quality data is greater than the second communication quality data, select a network of the physical SIM card as a primary network for data communication and select a network of the cloud SIM card as a backup network; or in a case where the first communication quality data is less than or equal to the second communication quality data, select a network of the cloud SIM card as a primary network for data communication and select a network of the physical SIM card as a backup network.

11. The electronic device according to claim 10, wherein the communication quality monitoring unit is further configured to monitor a data link of the primary network; and
correspondingly, the communication selection unit is further configured to:
in a case where the data link of the primary network is normal, continue using the primary network for data communication, and continuously monitor the data link of the primary network;
in a case where the data link of the primary network is abnormal, monitor a data link of the backup network, and select the backup network as the primary network for data communication in a case where the data link of the backup network is normal; and
in a case where data links of both the primary network and the backup network are abnormal, compare a network quality of the primary network and a network quality of the backup network, and select one of the primary network and the backup network with a better quality as the primary network for data communication.

12. The electronic device according to claim 8, wherein the physical SIM card and the cloud SIM card home to different network operators.

13. The electronic device according to claim 8, wherein the physical SIM card comprises, but is not limited to, an eSIM card and a surface-mount SIM card.

14. A device for dual-SIM communication, comprising:
a processor,
an encryptor,
a memory, and
one or more computer programs, wherein the one or more computer programs are stored in the memory and runnable on the processor;
wherein the one or more computer programs, when loaded and run by the processor, allow the processor to perform the method according to claim 1.

15. A machine-readable storage medium storing one or more executable instructions, wherein the one or more executable instructions, when loaded and executed by a machine, allow the machine to perform the method according to claim 1.

16. The method according to claim 2, wherein the physical SIM card comprises an eSIM card and a surface-mount SIM card.

17. The method according to claim 3, wherein the physical SIM card comprises an eSIM card and a surface-mount SIM card.

18. The method according to claim 4, wherein the physical SIM card comprises an eSIM card and a surface-mount SIM card.

19. The method according to claim 5, wherein the physical SIM card comprises an eSIM card and a surface-mount SIM card.

20. The method according to claim 6, wherein the physical SIM card comprises an eSIM card and a surface-mount SIM card.
